(19) United States
(12) Patent Application Publication
(10) Pub. No.: US 2006/0094835 A1
(43) Pub. Date: May 4, 2006

(54) Slurry loop polyolefin reactor

(76) Inventors: Louis Fouarge, Dilbeek (BE); Andre Lewalle, Bruxelles (BE)

Correspondence Address: FINA TECHNOLOGY INC, PO BOX 674412, HOUSTON, TX, 77267-4412, US

(21) Appl. No.: 10/528,713

(22) PCT Filed: Sep. 23, 2003
(86) PCT No.: PCT/EP03/10704

§ 371 Date: Aug. 11, 2005

(30) Foreign Application Priority Data
Sep. 23, 2002 (EP) 02078971.5
Oct. 17, 2002 (EP) 02079384.0

(51) Int. Cl. C08F 2/00

(52) U.S. Cl. 526/64

(57) ABSTRACT

The present invention discloses a slurry loop reactor comprising one or more loops, capable of improving the properties of the product by enhanced homogeneity of the circulating slurry.

The present invention relates to the polymerization of olefin monomers in a slurry loop reactor.

High density polyethylene (HDPE) was first produced by addition polymerization carried out in a liquid that was a solvent for the resulting polymer. That method was rapidly replaced by polymerisation under slurry conditions according to Ziegler or Phillips. More specifically slurry polymerisation was carried out continuously in a pipe loop reactor. A polymerization effluent is formed which is a slurry of particulate polymer solids suspended in a liquid medium, ordinarily the reaction diluent and unreacted monomer (see for Example U.S. Pat. No. 2,285,721). It is desirable to separate the polymer and the liquid medium comprising an inert diluent and unreacted monomers without exposing the liquid medium to contamination so that said liquid medium can be recycled to the polymerization zone with minimal or no purification. As described in U.S. Pat. No. 3,152,872, a slurry of polymer and the liquid medium is collected in one or more settling legs of the slurry loop reactor from which the slurry is periodically discharged to a flash chamber thus operating in a batch-wise manner.

The mixture is flashed in order to remove the liquid medium from the polymer. It is afterwards necessary to recompress the vaporized polymerization diluent to condense it to a liquid form prior to recycling it as liquid diluent to the polymerisation zone after purification if necessary.

Settling legs are often required to improve the polymer concentration in the slurry extracted from the reactor, They however present several problems as they impose a batch technique onto a continuous process.

EP-A-0,891,990 and U.S. Pat. No. 6,204,344 disclose two methods for decreasing the discontinuous behaviour of the settling legs and thereby for increasing the solids concentration. One method consists in replacing the discontinuous operation of the settling legs by a continuous retrieval of enriched slurry. Another method consists in using a more aggressive circulation pump.

These methods slightly improve the continuity of the circulation and thereby the solids content, but there is still ample room for improvement. Indeed, slurry loop reactors are not perfectly mixed reactors. The slurry is composed of a liquid phase and a solid phase. Because of the significant differences between the specific masses of the liquid and of the solids, and because of the very low viscosity of the liquid, the components of the slurry are separated by centrifugal force when traveling through a curve with the solids being pushed towards the outer part of the curve. There is thus a concentration profile in the normal section of the reactor. The centrifugal force exerted by the circulation pump is also very large and decreases significantly the solids concentration in the middle of the reactor accumulating the solids close to the walls. There are numerous other causes of heterogeneity such as for example:
the nature of the feed coming to the reactor that, under standard conditions, is made of mixed liquid and gas phases;
discontinuous catalyst feed, currently occurring with chromium-based catalysts;
discontinuous settling legs extraction.

When the reactor is pushed to its limits of operability, the energy consumption of the circulation pump increases on average and becomes less stable and the reactor temperature becomes unstable.

It is an object of the present invention to refrain the onset of the instabilities described hereabove.

It is another object of the present invention to produce a polymer with improved bulk density and reduced molecular weight distribution.

It is also an aim of the present invention to improve the catalyst productivity and therefore the reactor throughput.

It is another object of the present invention to improve the homogeneity of the flow in the loop reactor.

It is a further object of the present invention to increase the solids concentration in the reactor.

It is yet another object of the present invention to increase the production of polymer in a slurry loop reactor.

Accordingly, the present invention discloses a slurry loop reactor having one or more loops and comprising on at least one of the one or more loops, either a by-pass line (2) connecting two points of the same loop (1) by an alternate route having a different transit time than that of the main route and/or a modified circulation pump with internal re-circulation, and/or a mixing element that improves the homogeneity of the circulating slurry. Said slurry loop reactor is capable of improving the mixing within the reactor.

Throughout the present description the loops forming the slurry loop reactor can be in parallel or in series and additionally, each loop can be folded.

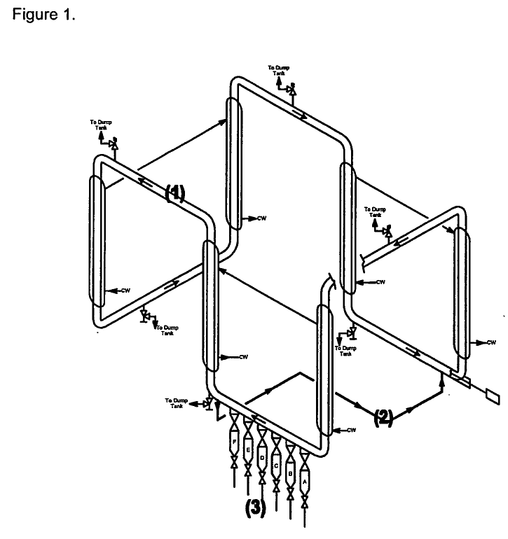

FIG. 1 represents schematically the loop reactor (1) with a by-pass line (2) inserted between two points of the main loop. It also includes the settling legs (3).

Optionally, the by-pass may be jacketed.

Any one or more of the loop reactor modifications recited here-above can be implemented on any of one or more of the loops in the reactor.

The by-pass line carries a fraction of the slurry of from 0.5 to 50% of the total flow rate, preferably of 1 to 15% of the total flow rate.

The flow time through the by-pass line is different from the time necessary to travel through the main loop as the routes have different lengths. This difference in travel time results in longitudinal mixing that improves the homogeneity of the slurry within the reactor.

Preferably, the distance traveled by the slurry in the by-pass is shorter than that traveled in the main loop, and the slurry is re-injected in the main loop at an angle of from 1 to 90 degrees, preferably at an angle of from 30 to 60 degrees and more preferably at an angle of about 45 degrees.

The diameter of the by-pass is less than that of the main loop and the ratio DB/DL of the by-pass diameter DB to the loop diameter DL is of from 1:12 to 1:2, preferably of from 1:6 to 1:3.

The present invention further discloses the use of a by-pass line connecting two points of the main loop (1) by an alternate route having a different transit time than that of the main route, for improving the homogeneity of the circulating fluid in a slurry loop reactor.

In a second embodiment according to the present invention, the homogeneity of the fluid circulating through a slurry loop reactor is improved by modifying the circulating pump so that it operates with a significantly reduced efficiency, of from 30 to 75%, significantly lower than the efficiency obtained on standard slurry loop reactors. The pump efficiency could potentially be reduced further.

This is achieved by allowing from 0.5 to 50% of the flow, and preferably from 1 to 25% of the flow, to be re-circulated from the pressure side of the impeller blade to the suction side of the same impeller blade.

The re-circulation is carried out by leaving an empty space between one or more blade(s) of the impeller and the shroud of the pump, said space being of the order of from 0.5 to 10% of the pump radius and preferably of from 1 to 5% of the pump radius.

Alternatively, the re-circulation can be achieved by the presence of holes in the impeller blades. The total surface of the holes is of from 0.1 to 35% and, preferably of 0.5 to 15%, of the surface of the blade measured in its central plane. The holes can have any shape and position and can be absent from some blades.

In a third embodiment according to the present invention, the radial homogeneity of the flow in the slurry loop reactor is improved by the insertion of fixed obstacles within the reactor.

The obstacles can be massive or in the shape of conduits.

The positions of the obstacles are selected to reduce the heterogeneities and are thus located where heterogeneities are most likely to occur such as for examples at curves or at pump discharge.

The polymer products obtained with the modified loop reactor according to the present invention have a bulk density that is from 1 to 5% higher than that of the polymer products obtained with the unmodified loop reactor.

The molecular weight distribution (MWD) is defined by the polydispersity index D which is the ratio Mw/Mn of the weight average molecular weight Mw to the number average molecular weight Mn. It is typically reduced by 5 to 15% in the polymer products obtained with the modified loop reactor according to the present invention.

The catalyst productivity is substantially improved without any loss in production. The catalyst productivity is typically increased by 10 to 50%.

This improvement in catalyst productivity is obtained thanks to an increase of the residence time in the reactor and to the extension of the stable operation window. It has been observed that the solids content, measured as the ratio of the particle mass flow rate to the total mass flow rate, is increased by at least 1.5%, preferably by at least 3%.

### EXAMPLES

The same loop reactor has been used to polymerize a given grade of high density polyethylene (HDPE) with and without a by-pass. The operating conditions were the same and they are summarised in Table I.

TABLE I

| | Without by-pass | With by-pass |
|---|---|---|
| Number of data | 414 | 296 |
| Temperature ° C. | 107 | 107.6 |
| [C2⁻] wt % | 4.97 | 4.80 |
| [C6⁻] wt % | 0.04 | 0.04 |
| Productivity (g/g) | 2652 | 3651 |
| Production (t/h) | 7565 | 7704 |
| HLMI g/10 min | 2.10 | 2.07 |

The HLMI was measured following the method of standard test ASTM D 1238 at 190° C. and under a load of 21.6 kg.

As can be observed, the catalyst productivity was substantially improved without any loss of production.

1-15. (canceled)

16. In a process for the polymerization of an alpha olefin in a slurry-type loop reactor system comprising:
(a) supplying at least one alpha olefin in a carrier liquid to a reactor system comprising at least one loop reactor;
(b) circulating said carrier liquid and monomer through said loop reactor while polymerizing said monomer in the presence of a catalyst system in said carrier liquid to form a slurry of polymer fluff particles in said carrier liquid;
(c) diverting the flow of said slurry through said loop reactor by at least one of:
(1) flowing a portion of said slurry through a bypass line extending from one location of said loop reactor to another location of said loop reactor;
(2) operating a circulating pump, circulating said slurry through said reactor at an efficiency of within the range of 30-75% of said pump capacity; and
(3) providing a plurality of obstacles in the flow path of said slurry within said loop reactor; and
(d) while continuing the introduction of said diluent and monomer into said loop reactor, withdrawing a portion of said slurry from said reactor as a polymer product.

17. The process of claim 16 wherein said slurry is diverted by flowing a portion of said slurry through a bypass line extending from one location of said reactor to a second location of said reactor.

18. The process of claim 17 wherein said bypass line carries a fraction of the slurry within the range of 0.5-50% of the total flow through said loop reactor.

19. The process of claim 17 wherein said bypass line carries a fraction of the slurry within the range of 1-15% of the total flow through said loop reactor.

20. The process of claim 17 wherein the slurry in the bypass line is reintroduced into said loop reactor at an angle within the range of 1-90°.

21. The process of claim 20 wherein the slurry in said bypass line is introduced into said loop reactor at an angle within the range of 30-60°.

22. The process of claim 20 wherein the slurry in said bypass line is introduced into said loop reactor at an angle of about 45°.

23. The process of claim 17 wherein said bypass line has an average diameter, DB, and said loop reactor has an average diameter, DL, and the ratio of DB/DL is within the range of 1:12 to 1:2.

24. The process of claim 23 wherein the ratio of DB/DL is within the range of 1:6 to 1:3.

25. The process of claim 16 wherein said slurry is circulated through said loop reactor by an impeller pump having a plurality of blades and said slurry is diverted by recirculating a portion of the slurry from the pressure side of the impeller blades of said pump to the suction side of the impeller blades of said pump.

26. The process of claim 25 wherein the portion of said slurry which is recirculated from the pressure side to the suction side of said impeller blades is within the range of 0.5-50% of the total flow through said loop reactor.

27. The process of claim 25 wherein the portion of said slurry which is recirculated from the pressure side to the suction side of said impeller blades is within the range of 1-25% of the total flow through said loop reactor.

28. The process of claim 25 wherein said slurry is diverted by the provision of a plurality of holes in at least some of said impeller blades.

29. The process of claim 28 wherein the total surface of area of the holes in said impeller blades within the range of 0.1-35% of the total surface area of said blades.

30. The process of claim 28 wherein the total surface of area of the holes in said impeller blades within the range of 0.5-15% of the total surface area of said blades.

31. The process of claim 25 wherein said pump has a pump shroud surrounding said impeller blades and wherein said impeller blades are configured to provide an empty space between at least one of said blades and said shroud.

32. The process of claim 31 wherein said empty space between said at least one blade and said pump shroud is within the range of 0.5-10% of the radius of said shroud.

33. The method of claim 32 wherein said empty space is within the range of 1-5% of the radius of said shroud.

34. The process of claim 16 wherein the flow of said slurry through said loop reactor is diverted by providing a plurality of obstacles in the flow path of the slurry flowing through said loop reactor.

35. The process of claim 16 wherein the polymer product recovered from said loop reactor has a bulk density which is from 1-5% greater than the bulk density recovered from said reactor system when it is operated without the diversion of slurry through said loop reactor as recited in claim 16.
